(19) United States
(12) Patent Application Publication
(10) Pub. No.: US 2025/0011142 A1
(43) Pub. Date: Jan. 9, 2025

(54) CRANE WITH DERRICK BALLAST

(71) Applicant: Liebherr-Werk Nenzing GmbH, Nenzing (AT)

(72) Inventors: Richard TORGHELE, Bartholomäberg (AT); Robert BARGEHR, Bürs (AT)

(21) Appl. No.: 18/733,645

(22) Filed: Jun. 4, 2024

(30) Foreign Application Priority Data
Jul. 6, 2023 (DE) 10 2023 117 808.3

(51) Int. Cl. B66C 23/60; B66C 1/62; B66C 23/06; B66C 23/36; B66C 23/74

(52) U.S. Cl. CPC B66C 23/60; B66C 1/625; B66C 23/06; B66C 23/74; B66C 23/36

(57) ABSTRACT

The disclosure relates to a crane comprising an undercarriage, a uppercarriage mounted rotatably on the undercarriage, a boom connected to the uppercarriage, a derrick boom connected to the uppercarriage, via which the boom is braced, a guide connected to the uppercarriage, and a derrick ballast comprising at least two ballast elements that can be stacked on top of one another and a cross member, which is connected to the derrick boom via a ballast bracing and to the uppercarriage via the guide. The cross member can be connected to a stack of ballast elements via a retaining element comprising first connecting means for releasably connecting the retaining element to second connecting means of the ballast elements of the stack. The retaining element can be connected to a partial stack of ballast elements of the stack by moving the retaining element and/or the cross member relative to the uncoupled stack.

### CROSS REFERENCE TO RELATED APPLICATION

The present application claims priority to German Patent Application No. 10 2023 117 808.3 filed on Jul. 6, 2023. The entire contents of the above-listed application are hereby incorporated by reference for all purposes.

### TECHNICAL FIELD

The present disclosure relates to a crane comprising an undercarriage, a uppercarriage mounted rotatably on the undercarriage, a boom connected to the uppercarriage in a luffing manner, a derrick boom connected to the uppercarriage in an articulated manner, via which the boom is braced, a guide connected to the uppercarriage and a derrick ballast, wherein the derrick ballast comprises at least two ballast elements which can be stacked on top of one another and a cross member which is connected to the derrick boom via a ballast bracing and to the uppercarriage via the guide, and to a derrick ballast for such a crane.

### BACKGROUND

Cranes of this type are also known as derrick cranes and typically have a crawler chassis. Due to the additional derrick ballast, these cranes are configured to lift and move particularly heavy loads. On these cranes, the main boom (hereinafter referred to as the “boom”—typically a lattice boom) and the derrick boom are connected to each other via an adjustable luffing boom. The derrick boom is typically connected to the adjustable A-frame of the uppercarriage via a derrick bracing. By adjusting the A-frame, the inclination of the derrick boom relative to the uppercarriage can be adjusted for erecting and dismantling the derrick. During crane operation, the angle of the derrick boom is generally unchanged. The luffing movement of the main boom is achieved by adjusting the luffing rope between the boom and derrick boom.

The moment that the boom brings into the boom system with the load it is carrying must therefore be absorbed by the derrick boom. In addition, the overall “crane” system must remain stable. This means that the overall center of gravity must lie within the tilting edges. When lifting heavy loads, this is not possible with a uppercarriage ballast alone. For this reason, the derrick ballast is required as an additional ballast. This is connected to the free end of the derrick boom via a variable-length ballast bracing. The length of the ballast bracing can be adjusted using hydraulic tension cylinders, for example.

Derrick ballasts in the form of a suspended ballast or a ballast trolley that can be moved on the floor with ballast elements stacked on it are known from the prior art. A suspended ballast can generally assume two operating modes: it can be set down on the floor or suspended on the variable-length ballast bracing. These two states are usually dependent on the load moment to be absorbed.

The horizontal distance between the axis of rotation of the uppercarriage or the axis of rotation of the uppercarriage and the center of gravity of the derrick ballast is referred to as the ballast radius. With suspended ballast, the ballast radius can be adjusted either via the inclination of the derrick boom or via a guide between the rear of the uppercarriage and the suspended ballast.

High ballasting is required for erecting long boom equipment. Once erected, the crane generally requires less ballasting for the projected loads. The disadvantage of a suspended ballast is that the crane or uppercarriage can only be rotated, moved or the suspended ballast shifted when the derrick ballast is lifted off the ground. However, this state can only be achieved if the system is balanced by a certain load on the hook. The larger or heavier the suspended ballast, the greater the minimum load on the hook must be. Depending on the configuration, this results in certain minimum loads on the hook to prevent the suspended ballast from being forced to drop. As long as the required minimum load on the hook is greater than the hook weight including lifting gear, the suspended ballast must be lowered when the load is removed from the hook. It is then no longer possible to turn, move the crane or shift the suspended ballast. This circumstance can severely restrict or complicate the planning of a lift.

### SUMMARY

The present disclosure is therefore based on the object of providing a solution for adapting such a derrick ballast simply, quickly and flexibly to the lifting task to be performed. In particular, it should be possible to change the weight of the derrick ballast in a simple, quick and flexible manner.

According to the disclosure, this object is achieved by a crane comprising an undercarriage, a uppercarriage mounted rotatably on the undercarriage, a boom connected to the uppercarriage in a luffing manner, a derrick boom connected to the uppercarriage in an articulated manner, via which the boom is braced, a guide connected to the uppercarriage and a derrick ballast configured in particular as a suspended ballast, wherein the derrick ballast comprises at least two ballast elements which can be stacked on top of one another and a cross member which is connected to the derrick boom via a ballast bracing and to the uppercarriage via the guide, wherein the cross member can be connected to a stack of ballast elements via at least one retaining element, wherein the retaining element comprises first connecting means for releasably connecting the retaining element to second connecting means of the ballast elements of the stack and is configured in such a way that by moving the retaining element and/or the cross member relative to the uncoupled stack, the retaining element can be connected to a partial stack of ballast elements of the stack and by a derrick ballast for the above-described crane. Advantageous embodiments of the disclosure result from additional features as described in the following description.

Accordingly, a crane is proposed which comprises an undercarriage, a uppercarriage mounted rotatably on the undercarriage, a boom connected to the uppercarriage in a luffing manner, a derrick boom connected to the uppercarriage in an articulated manner, a guide connected to the uppercarriage, and a derrick ballast. The undercarriage is particularly movable and can have a crawler chassis. The boom is braced via the derrick boom, preferably via a length-adjustable luffing boom as described above. The derrick boom is preferably connected to the adjustable A-frame of the uppercarriage via a derrick rigging system. The derrick boom can also be connected to an A-frame that is permanently connected to the uppercarriage via a boom rigging system, in particular a variable-length luffing cable.

The derrick ballast is configured in particular as a floating ballast.

The derrick ballast comprises at least two stackable ballast elements, which are preferably plate-shaped, and a cross member, which is connected to the derrick boom via a ballast bracing and to the uppercarriage via the aforementioned guide. The guide connecting the derrick ballast to the uppercarriage can have a variable length, which can be changed by an actuator, for example. This makes it possible to change the ballast radius and thus the maximum load capacity with the same ballasting.

According to the disclosure, the cross member can be connected to a stack of ballast elements via at least one retaining element, preferably via several retaining elements. The cross member can thus represent a ballast frame which can, for example, carry a partial ballast of the derrick ballast. When the term “the retaining element” is used in the following, this refers to at least one retaining element, i.e. it always includes the case of several retaining elements.

According to the disclosure, the retaining element comprises first connecting means for releasably connecting the retaining element to second connecting means of the ballast elements of the stack and is configured such that the retaining element can be connected to a partial stack of ballast elements of the stack by moving the retaining element and/or the cross member relative to the uncoupled stack which has been placed on the ground, for example.

In other words, the cross member or the retaining element(s) can be separated from the stack of ballast elements, for example after it has been placed on the ground, and then the retaining element(s) can be reconnected to some of the ballast elements of the stack or to a lowermost ballast element of the stack, so that the stack now held by the cross member is smaller than the previous stack (and thus represents a partial stack). This allows the weight of the ballast picked up by the cross member to be reduced. Of course, the reverse is also possible: a partial stack picked up can be placed on another partial stack of ballast elements, the connection with the retaining element(s) can be released and a connection with a larger stack than before can be established. This allows the weight of the ballast picked up by the cross member to be increased.

This makes it possible to optimally adapt the suspended ballast to the lift to be carried out or planned at any time and without any additional aids (such as an auxiliary crane). The limitations of known suspended ballasts described at the beginning can be significantly reduced with the solution according to the disclosure and the planning scope in the project planning of a lift can be significantly increased.

The solution according to the disclosure thus provides an autonomously-variably mountable suspended ballast, wherein in particular the term “autonomous” is to be understood as “operable without auxiliary devices” and the phrase “variably mountable” as “any mounting within the predetermined ballast units”.

A partial stack may consist of any number of ballast elements from the original stack. Even a single ballast element can be regarded as a partial stack, so that in the simplest case only the uppermost ballast element of the stack can be connected to the retaining element.

The at least one retaining element can be detachably connected to the ballast elements, for example via bolt connections, screw connections, hook-in connections or retaining claws, locking clamps, sliding bolts, connecting wedges, locking cylinders and/or connecting tubes. Any combination of the above-mentioned connecting means is also conceivable. A particularly simple solution results from the use of bolt connections.

In one possible embodiment, the derrick ballast comprises at least four retaining elements. Preferably, the cross member has exactly four retaining elements in order to minimize the complexity of the structure and reduce the effort involved in converting the ballast. However, devices with more than four retaining elements are also conceivable. Preferably, the second connecting means are located on the sides of the ballast elements. A preferred embodiment is one in which the retaining elements are arranged in plan view in four corner areas or at four corners of the cross member and can be connected to the second connecting means arranged on the sides of the ballast elements.

In a further possible embodiment, it is provided that the retaining element is adjustably mounted on the cross member. Preferably, the retaining element is mounted on the cross member so that it can be moved in a vertical direction. The term “vertical” refers to the case where the crane is standing on a flat, horizontal surface. Preferably, the retaining element can be fixed in at least two different positions on the cross member via locking means. The locking elements can be bolts.

This solution makes it possible, for example, to change the position of the first connecting means relative to the cross member and/or relative to the attachment points of the ballast bracing and the guide on the cross member. This can have the effect that different combinations of ballast elements or partial stacks of different sizes can be connected to the retaining element by adjusting the retaining element in order to change the weight of the derrick ballast. The retaining element can protrude downwards from the cross member, for example hanging downwards (e.g. in the event that the retaining element is or comprises a chain).

Alternatively or additionally, it may be possible to change the position of the first connecting means relative to the removed ballast elements, which may have been set down on the ground, by lifting the cross member using the guide, so that a different number of ballast elements can be connected to the retaining element. In this case, the retaining element can be fixed, i.e. not adjustable, on the cross member.

In a further possible embodiment, it is provided that the retaining element is configured as a tie rod or comprises a tie rod. This can be understood to mean any element that is configured to transmit tensile forces, for example a tube, a rod or a bar, which can be made of steel or a fiber composite material, for example. Preferably, the tie rod is oriented vertically. Preferably, the first connecting means are arranged one behind the other along the tie rod, i.e. they can form a linear arrangement, for example.

By adjusting the retaining element, the first connecting means therefore shift relative to the ballast plates or to their second connecting means, so that different first connecting means can be connected to different second connecting means and the number of ballast elements of the partial stack connected to the cross member can be varied. Alternatively, only one ballast element (in particular the lowest ballast element of the stack to be accommodated) can be connected to the retaining element, so that the first connecting means can be brought into overlap or engagement with second connecting means of another ballast element by adjusting the retaining element.

In a further possible embodiment, it is provided that the aforementioned locking means can be brought into engagement with the first connecting means of the retaining element in order to lock the retaining element releasably to the cross member, preferably connecting the retaining element to the second connecting means of the ballast elements with the same (i.e. identically configured) locking means.

In a further possible embodiment, it is provided that the locking means are configured as bolts or screws and the first and/or second connecting means comprise holes for receiving the bolts or screws. In the simplest case, the first and second connecting means are bolt receptacles and the locking means are bolts, wherein such bolts are also used to bolt the retaining element to the ballast elements of the partial stack. Instead of bolts, however, other locking means such as sliding bolts or screws or a combination of these means can also be used.

In a further possible embodiment, it is provided that the retaining element is configured as a chain or rope or comprises such a chain or rope. The retaining element can be a combination of tie rod and/or chain and/or rope. Alternatively or additionally, the retaining element may comprise at least one element made of a fiber composite material or be configured as such. Furthermore, the retaining element can be or comprise a pull tab.

In a further possible embodiment, it is provided that the derrick ballast is configured in such a way that the ballast elements attached to the cross member are located below the cross member, with the cross member preferably having an essentially rectangular shape in plan view. The ballast elements also preferably have an essentially rectangular shape when viewed from above, wherein preferably four retaining elements are arranged at the corners of the cross member and the ballast elements are thus held at four points on the cross member. This results in a stable and secure mounting of the ballast elements on the cross member.

In a further possible embodiment, it is provided that the retaining element and/or the cross member represents or comprises a steel structure, in particular a sheet metal and/or tubular structure or sheet metal and/or tubular framework structure. Likewise, an embodiment of the retaining element and/or the cross member (or at least parts thereof) as a casting and/or as an element produced by means of an additive manufacturing process or 3D printing is conceivable. The cross member can be made entirely or partially from a fiber composite material. This results in a high level of stability with a simultaneously reduced dead weight.

In a further possible embodiment, it is provided that the derrick ballast comprises a ballast base plate on which further ballast elements can be stored and/or stacked. The cross member with the ballast elements attached to it via the at least one retaining element represents in particular a partial ballast of the entire derrick ballast, which can be separated from the rest of the derrick ballast, in particular from the said ballast base plate, and can preferably be used separately as a suspended ballast. The cross member can be detachably connected to the ballast base plate with or without ballast elements attached to it (i.e. loaded or unloaded), in particular by means of bolt connections.

This allows the size of the “active” derrick ballast to be changed flexibly. For example, when erecting the boom, where a particularly high ballast moment is required, or for lifting tasks with particularly large loads, the entire derrick ballast can be used (i.e. the cross member with ballast elements attached to it is connected to the ballast base plate and further ballast stacks are stored on the latter). In a lifting operation with smaller loads, the cross member can be separated from the ballast base plate and used with the full stack or a partial stack of ballast elements as a smaller suspended ballast. The rest of the derrick ballast (i.e. the ballast base plate with the other ballast elements) can remain on the ground during the lifting task. If necessary, the partial ballast with cross member can be reconnected to the ballast base plate.

An assistance system and/or data recorded by sensors can be used to facilitate the connection process, which requires precise positioning of the cross member relative to the ballast base plate. For example, precise positioning of the cross member on the ballast base plate can be achieved using recorded movement data from the crane's travel and slewing gear and/or using GPS data from one or more GPS modules. Such GPS modules can, for example, be arranged on the uppercarriage, on the cross member and/or on the ballast base plate.

In a further possible embodiment, it is provided that the derrick ballast comprises a coupling part which is connected or connectable to the cross member and comprises attachment means to which the ballast bracing can be attached. The guide is preferably also connected to the coupling part, in particular pivotable about a horizontal pivot axis. The coupling part can be part of the derrick ballast. The cross member can be connected in one piece or firmly to the coupling part, e.g. welded. Alternatively, the cross member can be detachably connected to the coupling part via fastening elements. In the latter case, the first connecting means can also be adjusted relative to the uncoupled ballast elements by moving the cross member relative to the coupling part.

In a further possible embodiment, it is provided that the cross member comprises first fastening means which can be detachably connected to second fastening means of the ballast base plate. The first and second fastening means can be directly connectable, in particular boltable, to each other. Alternatively, the cross member and the ballast base plate can be connectable to each other via coupling elements (e.g. coupling strips or rods), which are connected, in particular bolted, to the first and second fastening means. Alternatively, the first fastening means can be arranged on the said coupling part.

In a further possible embodiment, it is provided that the ballast base plate comprises a central receiving area to which or in which the partial ballast comprising the cross member can be attached. The stack of ballast elements connected to the cross member can be placed on the receiving area. The ballast base plate preferably has a storage surface on either side of the central receiving area, on which further ballast elements can be placed. In this case, in the connected state (i.e. the entire derrick ballast is “active”), the cross member and the stack or partial stack of ballast elements connected to it can be arranged between at least two towers of further ballast elements, which are mounted on the ballast base plate.

In a further possible embodiment, it is provided that the second connecting means of the ballast elements of the stack, which can be connected to the first connecting means of a retaining element, lie on a common straight line. The straight line extends parallel and, in the connected state, in particular coaxially to the longitudinal axis of the retaining element. If several retaining elements are present, the second connecting means associated with the various retaining elements each lie on such a straight line, wherein the straight lines are preferably parallel to each other.

A translational movement of the retaining element relative to the second connecting means, in particular a vertical displacement of the retaining element, enables in particular a part of the first connecting means previously assigned to a first number of ballast elements of the stack to be brought into overlap or engagement with the second connecting means of a second number of ballast elements of the stack.

In other words, a translational movement of the retaining element means that the first connecting means, which were previously connected to a certain arrangement of second connecting means of the ballast elements, can now be brought into overlap or engagement with the second connecting means of other ballast elements, so that a different number or a partial stack of ballast elements are now connected to the retaining element by establishing the corresponding connections. This allows the ballasting of the partial ballast comprising the cross member to be changed. The ballast elements that are not connected to the retaining elements remain on the floor.

Alternatively, only one ballast element (in particular the lowest ballast element of the stack to be accommodated) can be connected to the retaining element, so that the corresponding first connecting means can be brought into overlap or engagement with second connecting means of another ballast element by adjusting the retaining element.

The present disclosure also relates to a derrick ballast for a crane according to the disclosure. This obviously has the same properties and advantages as the crane according to the disclosure. All embodiments and configuration options of the derrick ballast and/or its subcomponents described in relation to the crane therefore also apply to the derrick ballast according to the disclosure, in any combination.

### BRIEF DESCRIPTION OF THE FIGURES

Further features, details and advantages of the disclosure can be seen from the exemplary embodiments explained below with reference to the figures. The figures show in:

FIG. 1: a schematic general view (left-hand illustration) and an enlarged view of the derrick ballast (right-hand illustration) of an embodiment of the crane according to the disclosure;

FIG. 2: a perspective view of a first example of the cross member of the derrick ballast;

FIG. 3: a second embodiment of the cross member of the derrick ballast in a perspective view; and

FIGS. 4-8: lateral views of the cross member in different positions when converting the first partial ballast.

### DETAILED DESCRIPTION

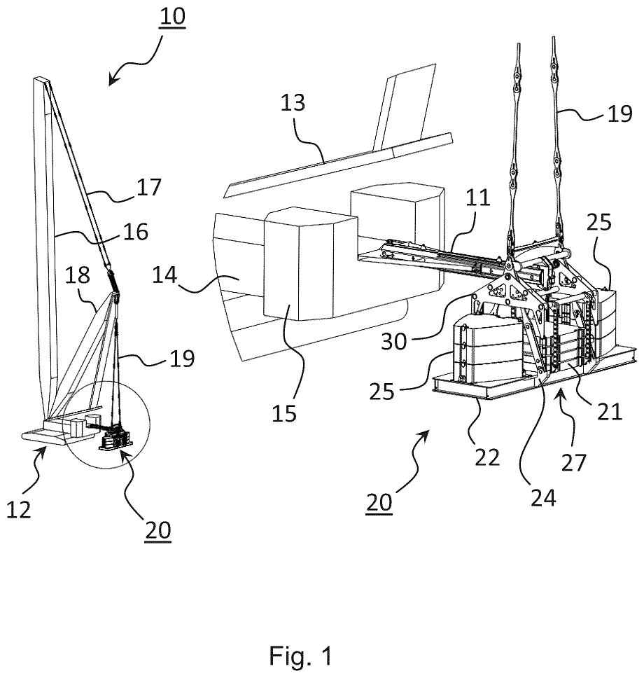

FIG. 1 shows in the left-hand figure a schematic, perspective overall view of an embodiment of the crane 10 according to the disclosure. This comprises a mobile undercarriage 12 and an uppercarriage 14 mounted on the undercarriage 12 so as to be rotatable about a vertical axis of rotation, at the rear of which there is a derrick ballast 20. The right-hand illustration shows an enlarged view of the rear of the uppercarriage, indicated by the circle in the left-hand illustration, together with the derrick ballast 20.

The crane 10 of the exemplary embodiment shown here is a crawler crane with a lattice boom as the main boom 16 (hereinafter only referred to as the “boom”), which is hinged to the uppercarriage 14 around a horizontal luffing axis. The undercarriage 12 comprises a crawler chassis and is supported on the ground via the two lateral crawler carriers of the crawler chassis. In addition to the boom 16, the crane 10 has a derrick boom 18, which is also hinged to the uppercarriage 14 so that it can pivot about a horizontal pivot axis. An uppercarriage ballast 15 with several ballast elements (stacked on top of each other to form two lateral ballast stacks in the exemplary embodiment shown here) is located at the rear of the uppercarriage. The derrick boom 18 is connected to the boom 16 via a boom bracing 17, in particular a variable-length luffing boom. The derrick boom 18 is in turn connected to the pivoting A-frame of the uppercarriage via a derrick bracing. The derrick boom 18 can also be connected via a fixed A-frame 13 connected to the uppercarriage via a boom bracing system 17, in particular a variable-length luffing cable.

In addition to the uppercarriage ballast 15, the crane 10 has a derrick ballast 20, which is configured as a suspended ballast. The derrick ballast 20 comprises a ballast base plate 22, on which several ballast elements 21, 25 are arranged. Derrick ballast 20 is connected to the rear of the uppercarriage via a preferably length-adjustable guide 11 and to the tip or free end of the derrick boom 18 via a length-adjustable ballast bracing 19. In the exemplary embodiment shown here, the ballast bracing 19 comprises two parallel bracing strands, the length of which can be adjusted, for example, by means of a hydraulic tension cylinder in each case, but at least one cylinder can be adjustable and thus the weight actively acting by the derrick ballast 20 can be height-adjustable.

With regard to the functions of the luffing boom, derrick bracing and ballast bracing 19 as well as the derrick ballast 20, reference is made to the introductory remarks, which also apply to the crane 10 according to the exemplary embodiment shown here. A repetitive explanation is therefore largely dispensed with.

In the exemplary embodiment shown here, the derrick ballast 20 is configured to be divisible. The derrick ballast 20 comprises a first partial ballast, which comprises a centrally arranged stack of ballast elements 21 and a cross member 30, and a second partial ballast, which comprises the ballast base plate 22 and two lateral stacks of further ballast elements 25. In the connected state, the first partial ballast is arranged in a central receiving area 27 of the derrick ballast 20. The derrick ballast 20 is connected to the guide 11 and the ballast bracing 19 via the cross member 30 and can therefore be lifted over the cross member when connected.

The first partial ballast comprises first fastening means 34, while the ballast base plate 22 has second fastening means 24 in the region of the central receiving area 27. The first partial ballast can be detachably connected, in particular bolted, to the ballast base plate 22 and thus to the second partial ballast via the first and second fastening means 24, 34, so that the derrick ballast 20 can be lifted together or brought into the floating state. The first and second fastening means 24, 34 can be connected to each other directly or via coupling elements. In the exemplary embodiment of FIG. 1, coupling rods are arranged between the fastening means 24, 34.

The guide 11 is preferably connected to the uppercarriage 14 so that it can pivot about a horizontal pivot axis and can preferably be pivoted about said pivot axis by means of an actuator, e.g. one or more hydraulic cylinders. This allows the derrick ballast 20 to be adjusted vertically and, for example, set down on the ground or lifted off the ground. At the same time, the ballast bracing 19 can be adjusted, in particular via the aforementioned tension cylinders. In particular, the guide 11 is also connected to the derrick ballast 20 so that it can pivot about a horizontal pivot axis.

For heavy lifting tasks where large loads have to be moved or when erecting the boom 16, a large ballast moment is required so that the first and second partial ballasts are connected to each other and the entire derrick ballast 20 can be used as a suspended ballast. For many lifting tasks, however, a lower ballast moment is required. In this case, the first partial ballast with the cross member 30 and the ballast stack 21 can be detached from the ballast base plate 22 or from the second partial ballast and used as a smaller suspended ballast. The second partial ballast then remains on the ground and can be reconnected to the first partial ballast at a later time. The coupling process can be supported by a positioning system to ensure that the first partial ballast is lowered precisely, for example by detecting the position of the lowered second partial ballast and the position of the crane 10 and/or the first partial ballast. This can be realized, for example, with the aid of recorded movement data of the travel and slewing gear or by means of GPS systems.

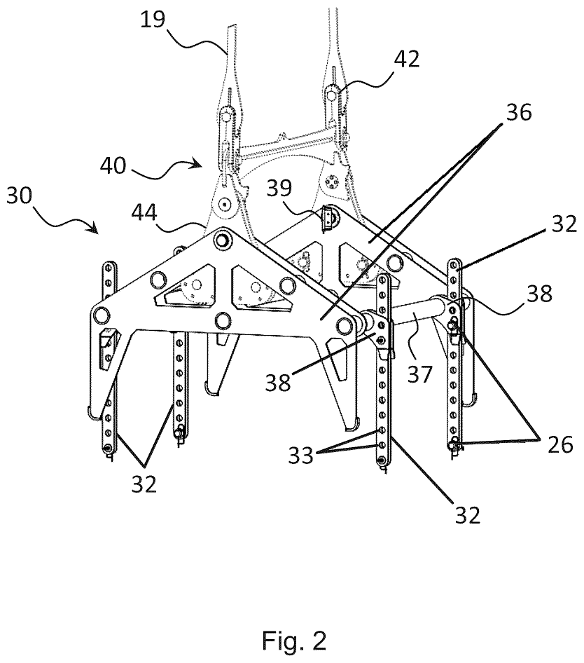

FIG. 2 shows a perspective view of a first exemplary embodiment of the cross member 30 of the first partial ballast. This corresponds to the embodiment variant shown in FIG. 1. The cross member 30 comprises two profile parts 36 which, when viewed from the side, have an essentially triangular shape and are aligned parallel to one another. Other shapes are of course also conceivable, e.g. a rectangular shape when viewed from the side. The profile parts 36 are connected to one another via connecting pieces 37; in the present exemplary embodiment, these are two coupling rods 37, which connect the lower corners of the triangular profile parts 36.

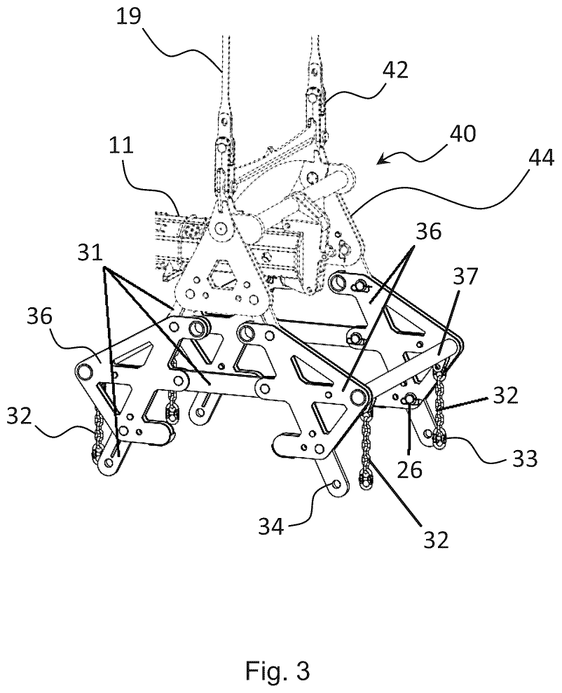

For example, two fork clamps 38 are attached to each of the coupling rods 37, in each of which a retaining element 32 is accommodated. In the exemplary embodiment shown here, the retaining elements 32 are configured as vertically oriented, elongated retaining rods, which can be made of steel or a fiber composite material, for example. Alternative forms of the retaining elements 32 are also conceivable, e.g. chains (see FIG. 3), ropes, pull straps or the like.

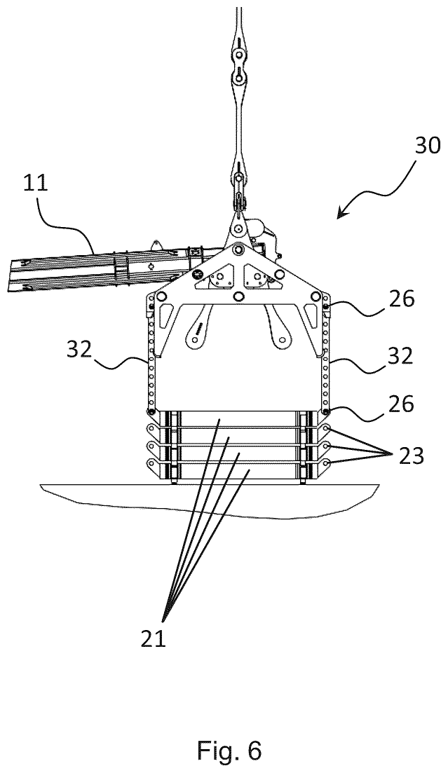

The four retaining elements 32 have a plurality of holes which act as first connecting means 33. These are configured in particular as bolt receptacles for forming bolt connections with corresponding bolts 26, but can also have a different shape, e.g. hook elements. In the exemplary embodiment shown here, the first connecting means 33 are arranged one behind the other along the retaining elements 32 and simultaneously serve to detachably fasten the ballast elements 21 to the retaining elements 32 and to fasten the retaining elements 32 to the forks 38. For this purpose, the ballast elements 21 have corresponding second connecting means 23 on the sides, which can be configured as bolt receptacles on laterally projecting connecting sections (see FIG. 6). The forks 38 also have corresponding connecting means. The connection between retaining elements 32 and forks 38 as well as between retaining elements 32 and ballast elements 21 is made in particular via locking bolts 26. Alternatively, a screw connection would be conceivable.

The retaining elements 32 can be detachably fastened in the forks 38, so that by pulling the locking bolts 36, which act as locking means 36, the retaining elements 32 can be moved relative to the cross member 30 and, in particular, adjusted in the vertical direction. They can then be bolted in a different position in the forks 38, for example by using other first connecting means 33. This allows the length of the retaining elements 32 to be varied downwards in the direction of the ballast elements 21, with the increment depending on the distances between the first connecting means 33.

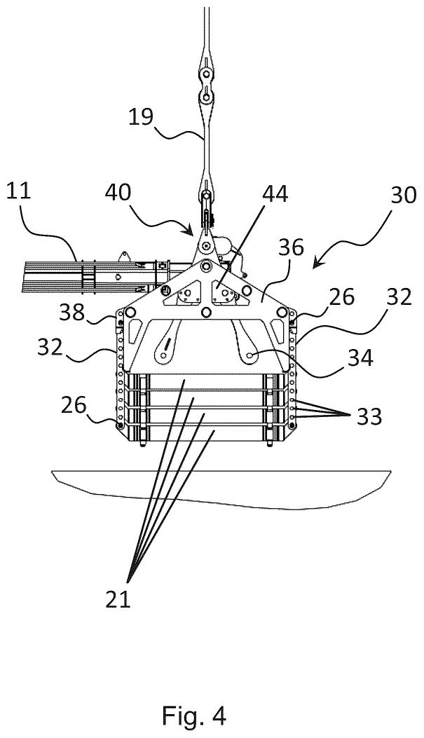

This configuration allows the number of ballast elements 21 attached to the retaining elements 32 and thus picked up by the cross member 30 to be varied flexibly and easily. For example, it is possible to place the ballast stack on the floor, loosen the connection to the retaining elements 32, lift the retaining elements 32 and/or the cross member 30 and connect a partial stack (i.e. a stack with fewer ballast elements 21 stacked on top of each other than the previously placed stack) to the retaining elements 32. This allows the weight of the first partial ballast to be changed quickly and easily. This process is shown by way of example in FIGS. 4-7 in lateral views of the cross member 30, the first exemplary embodiment of the cross member of FIG. 2 being used for this purpose.

FIG. 4 shows the first partial ballast in the ballasted state (in this exemplary embodiment, there are four ballast elements 21 arranged one above the other). Here, only the lowest ballast element 21 can be connected to the retaining elements 32 via locking bolts 26, while the other ballast elements 21 lie on top of each other and are connected to each other, for example via other connecting elements (e.g. interlocking projections and recesses), so that they do not slip. Alternatively, due to the plurality of first connecting means 33, it may be provided that all ballast elements 21 are connected to the retaining elements 32.

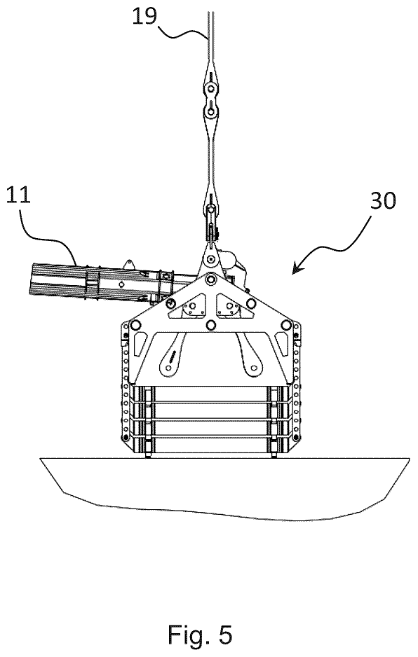

To reduce the weight of this partial ballast, it is set down on the floor by lowering the guide 11, as shown in FIG. 5. In this unloaded state, the connections between the ballast elements 21 (i.e. the lowest ballast element 21 in the example shown) and the retaining elements 32 can be released. The guide is then raised so that the crosspiece 30 and thus also the retaining elements 32 move in a vertical direction relative to the set-down stack 21. The crosspiece 30 is raised until the first connecting means 33 of the retaining elements 32 are at the level of the second connecting means 23 of those upper ballast elements 21 that are to be reconnected to the crosspiece 30 in the weight-reduced configuration. In the exemplary embodiment of FIG. 6, only the uppermost ballast element 21 is to be connected to the cross member 30, this ballast element 21 then forming a partial stack of the original stack of four ballast elements 21. The second connecting means 23 of the uppermost ballast element 21 are bolted to the matching (in this exemplary embodiment, the lowermost) first connecting means 33 of the retaining elements 32 (see FIG. 6).

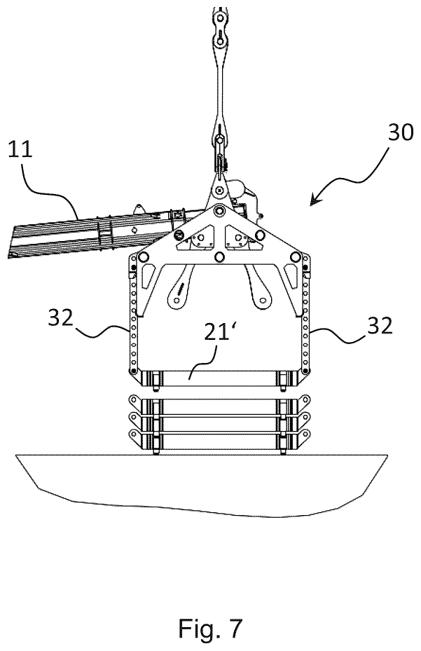

The crosspiece 30 is then raised again, wherein the released or uncoupled ballast elements 21 of the original stack (in FIG. 7 these are the lower three ballast elements 21) remain on the floor and only the partial stack 21′ (in FIG. 7 the uppermost ballast element 21′) connected to the retaining elements 32 is raised. This now provides a suspended ballast with reduced weight.

In order to change the ballasting again, the partial stack 21′ is set down again on the deposited ballast elements 21, the connection of the retaining elements 32 is released, the crosspiece 30 is lowered by a suitable distance and the second connecting means 23 of the desired partial ballast (or those of the lowest ballast element 21 of the desired partial ballast) are reconnected to the retaining elements 32.

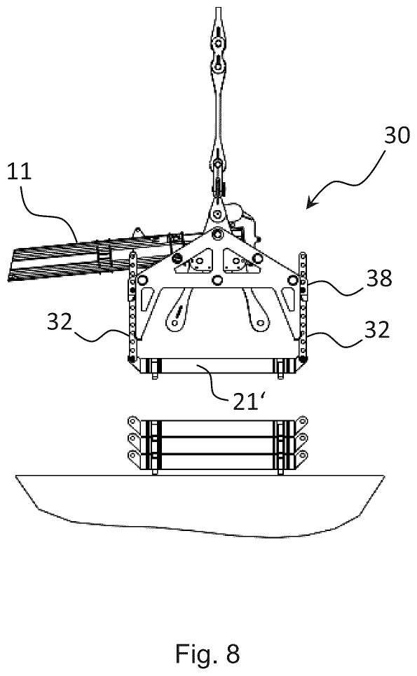

Alternatively, the connections between the retaining elements 32 and the forks 38 can be loosened and the retaining elements 32 can be moved relative to the cross member 30 for re-ballasting. This option is shown in FIG. 8 after the partial stack 21′ has been re-ballasted and lifted.

As already mentioned, it is possible to connect only the lowest ballast element 21 of the stack to be lifted to the retaining elements 32 (as shown in FIGS. 4-8), or to connect all ballast elements 21 of the lifted stack. In the former case, the first connecting means 33 can also be arranged only in an upper region of the retaining elements 32 in order to be able to connect the retaining elements 32 to the forks 38 in different positions relative to the cross member 30.

As shown in FIG. 2, the first partial ballast may comprise a coupling part 40, which has stop means 42 (in particular bolt receptacles) for fastening the ballast bracing 19 and a corresponding connection point for the guide 11. The cross member 30 can be detachably connected to the coupling part 40. FIG. 2 shows a configuration in which the profile parts 36 represent sheet metal structures, each with an intermediate space, into which lugs 44 of the coupling part 40 can be inserted. The lugs 44 can be detachably connected to the profile parts 36 via fastening elements 39, for example bolts.

As can be seen in FIG. 1 and also in FIGS. 4-8, in one exemplary embodiment the first fastening means 34 for connecting the first partial ballast to the ballast base plate 22 can be arranged on the coupling part 40, for example on extensions of the aforementioned lugs 44, so that the cross member 30 is not directly connected either to the guide 11 and ballast bracing 19 or to the ballast base plate 22.

FIG. 3 shows another exemplary embodiment of the cross member 30 according to the disclosure. Here, the coupling part 40 is also configured differently and does not have tabs with first fastening means 34. Instead, the latter are formed on the cross member 30. In this exemplary embodiment, this comprises four profile parts 36, wherein two profile parts 36 are connected to each other on one side via coupling pieces 31 (e.g. in the form of coupling strips or rods, as shown in FIG. 3, wherein the coupling pieces 31 can also be configured as tubular or shaped profile constructions), in particular detachably. Again, the profile parts 36 of each side are connected to one another via connecting pieces 37, with the retaining elements 32 being arranged on the connecting pieces 37. The cross member 30 can again be detachably or firmly connected to the coupling part 40.

As in the embodiment of FIG. 2, the retaining elements 32 can be configured as tie rods. FIG. 3 shows another embodiment in which the retaining elements 32 are configured as chains which hang downwards from the connecting pieces 37 and each have a first connecting means 33 on the underside for connection to the respective lowest ballast element 21 of the stack to be lifted. In this exemplary embodiment, the first connecting means 33 are configured as eyelets or carabiners or pull straps, although alternatively connecting parts with one or more holes for receiving bolts or screws can also be provided. The process of re-ballasting is analogous to the process shown in FIGS. 4-7.

Preferably and independently of the embodiment shown, the cross member 30 can remain attached to the coupling part 40 alone or be removed completely, depending on the ballasting variant.

The cross member 30 represents the support structure of the first partial ballast of the derrick ballast 20 according to the disclosure, i.e. the support structure of the “autonomously-variably divisible suspended ballast” realized in this way. The cross member 30 can be a steel construction, which can be manufactured, for example, in the form of a sheet metal or tubular truss construction, a cast piece or from a 3D printing process. In addition, the cross member 30 can be made of alternative materials such as fiber composites, high-strength aluminum, etc.

Bolts, screws, retaining claws, locking clamps, sliding bolts, connecting wedges, locking cylinders and/or locking tubes can be used as connecting elements to connect the retaining elements 32 to the cross member 30 and/or to the ballast elements 21.

### LIST OF REFERENCE CHARACTERS

10 crane
11 guide
12 undercarriage
13 bracing frame/A-frame
14 uppercarriage
16 boom
17 boom bracing
18 derrick boom
19 ballast bracing
20 derrick ballast
21 ballast element
21′ ballast element
22 ballast base plate
23 second connecting means
24 second fastening means
25 further ballast elements
26 locking means
27 central receiving area
30 cross member
31 coupling piece
32 retaining element
33 first connecting means
34 first fastening means
36 profile part
37 connecting piece
38 clamp
39 fastening element
40 coupling part
42 stop means
44 lug

1. A crane, comprising an undercarriage, an uppercarriage mounted rotatably on the undercarriage, a boom connected to the uppercarriage in a luffing manner, a derrick boom connected to the uppercarriage in an articulated manner, via which the boom is braced, a guide connected to the uppercarriage, and a derrick ballast, wherein the derrick ballast comprises at least two ballast elements which are configured to be stacked on top of one another to form a stack of ballast elements and a cross member which is connected to the derrick boom via a ballast bracing and to the uppercarriage via the guide,
wherein
the cross member is configured to be connected to the stack of ballast elements via a retaining element, wherein the retaining element comprises first connecting means for releasably connecting the retaining element to second connecting means of at least one ballast element of the at least two ballast elements of the stack of ballast elements and is configured in such a way that by moving the retaining element and/or the cross member relative to the stack of ballast elements, while the stack of ballast elements is uncoupled from the retaining element, the retaining element is configured to be connected to a partial stack of ballast elements of the stack of ballast elements.

2. The crane according to claim 1, wherein the derrick ballast comprises at least four retaining elements configured to be connected to the second connecting means on sides of the at least two ballast elements, wherein the at least four retaining elements are arranged at four corner regions of the cross member in plan view.

3. The crane according to claim 1, wherein the retaining element is adjustably mounted on the cross member, displaceable in a vertical direction, and is configured to be fixed in at least two different positions on the cross member via locking means, wherein the retaining element projects downwards from the cross member.

4. The crane according to claim 3, wherein the retaining element is configured as a tie rod or comprises a tie rod which is oriented vertically, wherein the first connecting means are arranged one behind the other along the tie rod.

5. The crane according to claim 3, wherein the locking means are configured to be brought into engagement with the first connecting means of the retaining element in order to lock the retaining element releasably to the cross member, wherein a connection of the retaining element to the second connecting means of the at least one ballast element of the at least two ballast elements is effected with the same locking means.

6. The crane according to claim 3, wherein the locking means are configured as bolts or screws and the first and/or second connecting means comprise bores for receiving the bolts or screws.

7. The crane according to claim 1, wherein the retaining element is configured as a chain or rope or comprises such a chain or rope.

8. The crane according to claim 1, wherein the derrick ballast is configured such that the at least two ballast elements attached to the cross member are located below the cross member, wherein the cross member has a substantially rectangular shape in a plan view.

9. The crane according to claim 1, wherein the retaining element and/or the cross member comprises a steel structure.

10. The crane according to claim 9, wherein the retaining element and/or the cross member comprises a sheet metal and/or tubular structure and/or at least one casting and/or at least one element manufactured by means of an additive manufacturing process and/or at least one element manufactured from a fiber composite material.

11. The crane according to claim 1, wherein the derrick ballast comprises a ballast base plate on which further ballast elements are configured to be mounted, wherein the cross member with or without the at least two ballast elements attached thereto is configured to be detachably connected to the ballast base plate.

12. The crane according to claim 11, wherein the derrick ballast comprises a coupling part, which is connected or connectable to the cross member and comprises stop means, to which the ballast bracing is configured to be fastened, wherein the coupling part is connected to the guide.

13. The crane according to claim 12, wherein the coupling part is connected to the guide so as to be pivotable about a horizontal pivot axis.

14. The crane according to claim 12, wherein the cross member or the coupling part comprises first fastening means which are configured to be releasably connected to second fastening means of the ballast base plate.

15. The crane according to claim 12, wherein the ballast base plate comprises a central receiving region, to which the cross member is configured to be fastened and on which the stack of ballast elements connected to the cross member is configured to be deposited, wherein the ballast base plate comprises depositing surfaces on both sides of the central receiving region, on which further ballast elements are configured to be deposited.

16. The crane according to claim 1, wherein the second connecting means of the at least two ballast elements of the stack of ballast elements, which are configured to be connected to the first connecting means of the retaining element, are located on a common straight line, which extends parallel and, in a connected state, coaxially to a longitudinal axis of the retaining element, wherein, by a translational movement of the retaining element relative to the second connecting means, a part of the first connecting means previously associated with a first number of ballast elements of the stack of ballast elements is configured to be brought into overlap or engagement with the second connecting means of a second number of ballast elements of the stack of ballast elements.

17. A derrick ballast for a crane according to claim 1.
